(19) United States
(12) Patent Application Publication
(10) Pub. No.: US 2016/0070074 A1
(43) Pub. Date: Mar. 10, 2016

(54) PASSIVELY ALIGNING OPTICAL FIBERS WITH RESPECTIVE LIGHT SOURCES IN A PARALLEL OPTICAL COMMUNICATIONS MODULE

(71) Applicant: Avago Technologies General IP (Singapore) Pte. Ltd., Singapore (SG)

(72) Inventors: Tak Kui Wang, San Jose, CA (US); Ye Chen, San Jose, CA (US); Hui Xu, Santa Clara, CA (US); Chung-Yi Su, Fremont, CA (US)

(21) Appl. No.: 14/482,587

(22) Filed: Sep. 10, 2014

(51) Int. Cl. G02B 6/42

(52) U.S. Cl. CPC G02B 6/423; G02B 6/4296

(57) ABSTRACT

A parallel optical communications module is provided that passively simultaneously aligns ends of a plurality of optical fibers with respective light sources of the module. A fiber assembly of the module holds the ends of a plurality of optical fibers at precisely-defined locations relative to mating features of the assembly. An optical bench of the module has a plurality of light sources mounted thereon at precisely-defined locations relative to mating features of the optical bench. When the mating features of the fiber assembly are fully engaged with the mating features of the optical bench, the ends of the optical fibers are precisely aligned with the respective light sources with sufficient precision to meet tight tolerances associated with the smaller-diameter cores of single-mode optical fibers.

### TECHNICAL FIELD OF THE INVENTION

The invention relates to optical communications. More particularly, the invention relates to precisely passively aligning ends of a plurality of optical fibers with respective light sources in a parallel optical communications module.

### BACKGROUND OF THE INVENTION

Parallel optical communications modules have a plurality of optical channels, each of which includes a respective optoelectronic element that is optically aligned with an end of a respective optical fiber. The parallel optical communications module may be a parallel optical transceiver module having both transmit and receive optical channels, a parallel optical transmitter module having only transmit optical channels, or a parallel optical receiver module having only receive optical channels. The optoelectronic elements are either light sources (e.g., laser diodes or light-emitting diodes (LEDs)) or light detectors (e.g., P-intrinsic-N (PIN) photodiodes). The optical fibers are either multi-mode optical fibers or single-mode optical fibers.

Multi-mode fibers are typically used in shorter network links whereas single-mode fibers are typically used in longer network links that have higher transmission bandwidths. The diameter of the light-carrying core of a typical single-mode fiber is between about 8 and 10 micrometers (microns) whereas the diameter of the light-carrying core of a typical multi-mode fiber is about 50 microns or greater. Consequently, the alignment tolerances for aligning light sources with the cores of single-mode fibers are much tighter than the alignment tolerances for aligning light sources with the cores of multi-mode fibers. For this reason, active alignment techniques are typically used to align single-mode fibers with their respective light sources whereas passive alignment techniques are often used to align multi-mode fibers with their respective light sources.

Active alignment techniques typically involve using a machine vision system to align the fibers with their respective light sources and test and measurement equipment to test and measure the optical signal launched into the optical fiber by the light source as the optical signal passes out of the opposite end of the fiber. By using these active alignment techniques and equipment, a determination can be made as to whether the light source and the optical fiber are in precise alignment with one another.

Passive alignment techniques are performed without the laser being turned on. Typically, passive alignment is accomplished by aligning the component with a vision system and a precision alignment stage. Passive alignment can also be performed by mating a connector module that holds the ends of the optical fibers with the parallel optical communications module. Mating features on the connector module and on the parallel optical communications module ensure that the act of mating them brings the ends of the fibers into precise alignment with the respective light sources. When multi-mode optical fibers are used, such passive alignment techniques can provide sufficient alignment precision due to the relaxed alignment tolerances associated with the relatively large diameter of the fiber core.

Active alignment processes are much more costly and time consuming to perform than passive alignment processes and are difficult to perform in the field. Accordingly, it would be desirable to provide a parallel optical communications module that enables ends of a plurality of single-mode optical fibers to be precisely passively aligned without turning on the respective light sources of the module. Furthermore, it is desirable to provide a mechanism for alignment without having to use a vision system and precision alignment stage.

### SUMMARY OF THE INVENTION

The invention is directed to a parallel optical communications module in which ends of a plurality of optical fibers are simultaneously passively aligned with respective light sources of the module with high precision. The parallel optical communications module comprises an optical bench and an optical fiber assembly. The optical bench (OB) has at least a first optoelectronic (OE) chip mounted on a first mounting surface thereof. The first OE chip or chips have at least N light sources, where N is a positive integer that is greater than or equal to 1. The N light sources form at least a first array of light sources. The OB has first and second alignment feature sets integrally formed therein. The first alignment feature set is used for precisely aligning the first OE chip or chips on the OB in X, Y and Z dimensions of an X, Y, Z Cartesian coordinate system.

The optical fiber assembly is mounted on the OB and holds ends of at least N optical fibers. The optical fiber assembly has at least a third alignment feature set thereon. The ends of the optical fibers are held in precise positions in the optical fiber assembly relative to the third alignment feature set. The full engagement of the third alignment feature set with the second alignment feature set precisely aligns the ends of the N optical fibers with respective light sources of the N light sources in the X, Y and Z dimensions.

The method is a method for simultaneously passively aligning ends of a plurality of optical fibers with respective light sources in a parallel optical communications module. The method comprises providing the OB and mounting the optical fiber assembly on the OB, where the mounting of the optical fiber assembly on the OB causes the third alignment feature set to fully engage the second alignment feature set, which precisely aligns the ends of the N optical fibers with respective light sources of the N light sources in the X, Y and Z dimensions.

These and other features and advantages of the invention will become apparent from the following description, drawings and claims.

### BRIEF DESCRIPTION OF THE DRAWINGS

FIG. 1 illustrates a top perspective view of the parallel optical communications module in accordance with an illustrative embodiment.

FIG. 2 illustrates a top perspective view of an optical bench of the module shown in FIG. 1 with the fiber assembly and the fibers removed to show details of the optical bench.

FIG. 3 illustrates an enlarged top perspective view of the portion of the optical bench shown in FIG. 2 within the dashed circle labeled 7 with the OE chips and bond wires removed to allow features of the optical bench to be more clearly seen.

FIG. 4 illustrates an enlarged top perspective view of the portion of the optical bench within the dashed circle labeled 7 in FIG. 2, but with the OE chip being visible.

FIG. 5 illustrates a top perspective view of the parallel optical communications module shown in FIG. 1 and shows optical beams that are produced by the light sources (not shown) of the OE chips and received in the ends of the cores of the optical fibers held in the fiber assembly.

FIG. 6 illustrates a bottom perspective view of the fiber assembly shown in FIG. 1 having V-grooves formed therein.

FIG. 7 illustrates a bottom perspective view of the fiber assembly shown in FIG. 6 with single-mode optical fibers disposed in some of the V-grooves and with first and second alignment fibers disposed in the outermost V-grooves.

FIG. 8 illustrates a bottom perspective view of the fiber assembly shown in FIG. 7 after a cover has been secured by epoxy (not shown) to the fiber assembly.

FIG. 9 illustrates a bottom perspective view of the parallel optical communications module shown in FIG. 1 showing the epoxy that is used to secure the fibers in the respective V-grooves and to secure the cover to the fiber assembly.

FIG. 10 illustrates a cross-sectional view of the parallel optical communications module shown in FIG. 1 taken along line A-A′.

### DETAILED DESCRIPTION OF AN ILLUSTRATIVE EMBODIMENT

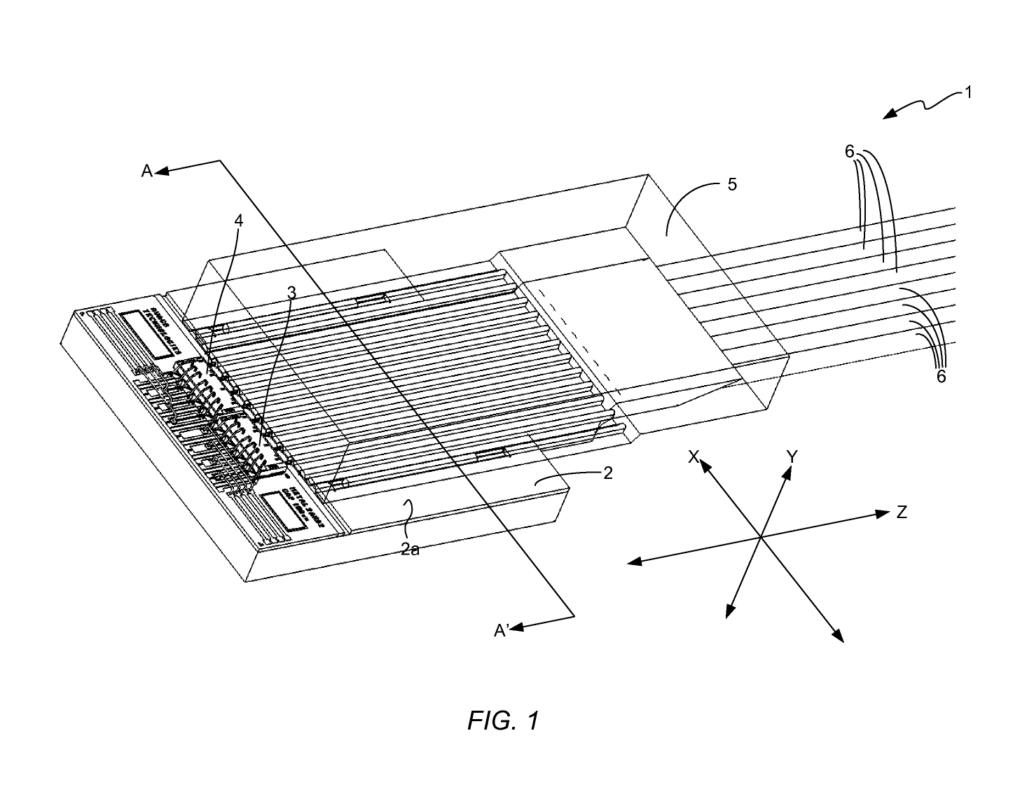

In accordance with embodiments of the invention, a parallel optical communications module is provided in which ends of a plurality of optical fibers are simultaneously passively aligned with respective light sources of the module with high precision. A fiber assembly of the module holds the ends of the optical fibers at precisely-defined locations relative to mating features of the fiber assembly. An optical bench of the module has a plurality of light sources mounted thereon at precisely-defined locations relative to mating features of the optical bench. When the mating features of the fiber assembly are fully engaged with the mating features of the optical bench, the ends of the optical fibers are simultaneously passively aligned with the respective light sources with sufficiently high precision to meet the tight tolerances associated with aligning the smaller cores of single-mode optical fibers with light sources. Illustrative, or exemplary, embodiments of the parallel optical communications module will now be described with reference to FIGS. 1-10, in which like reference numerals are used to represent like elements, features or components.

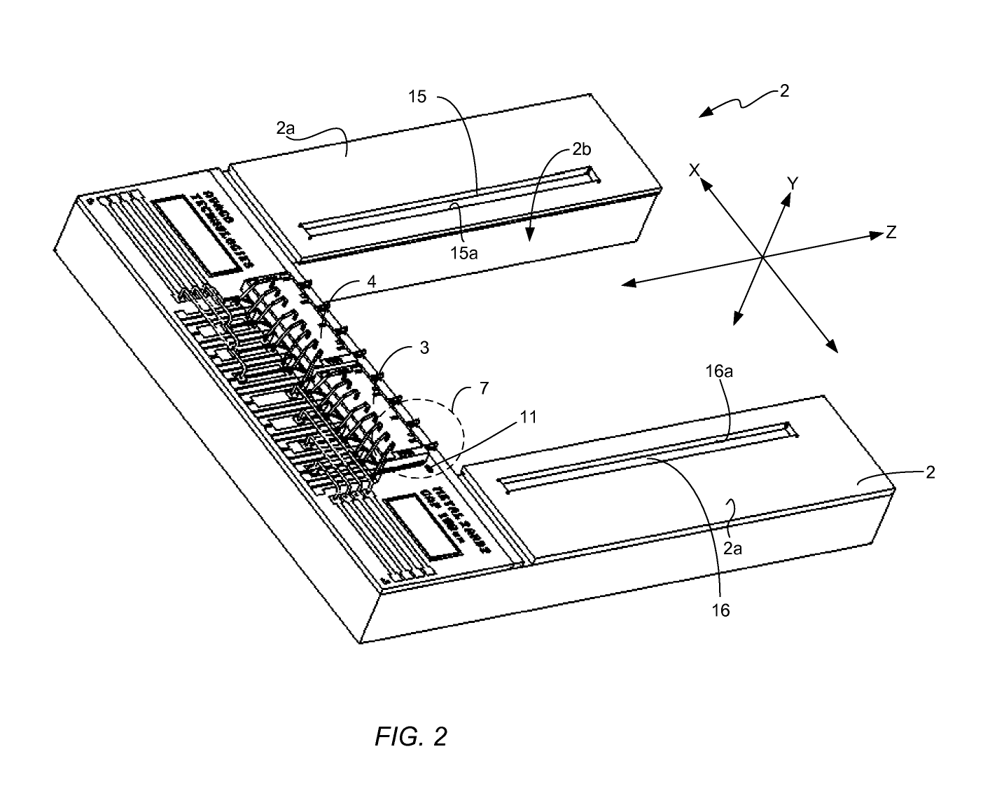

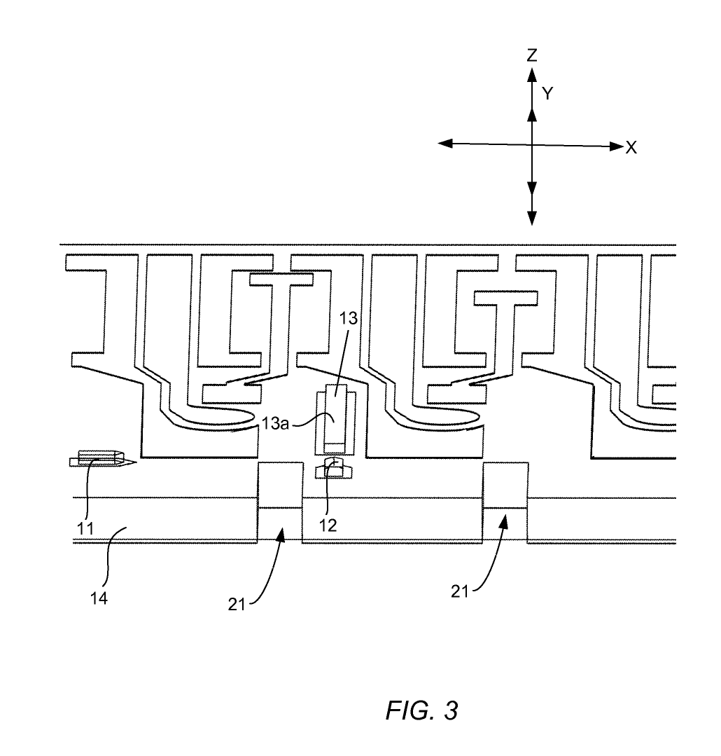

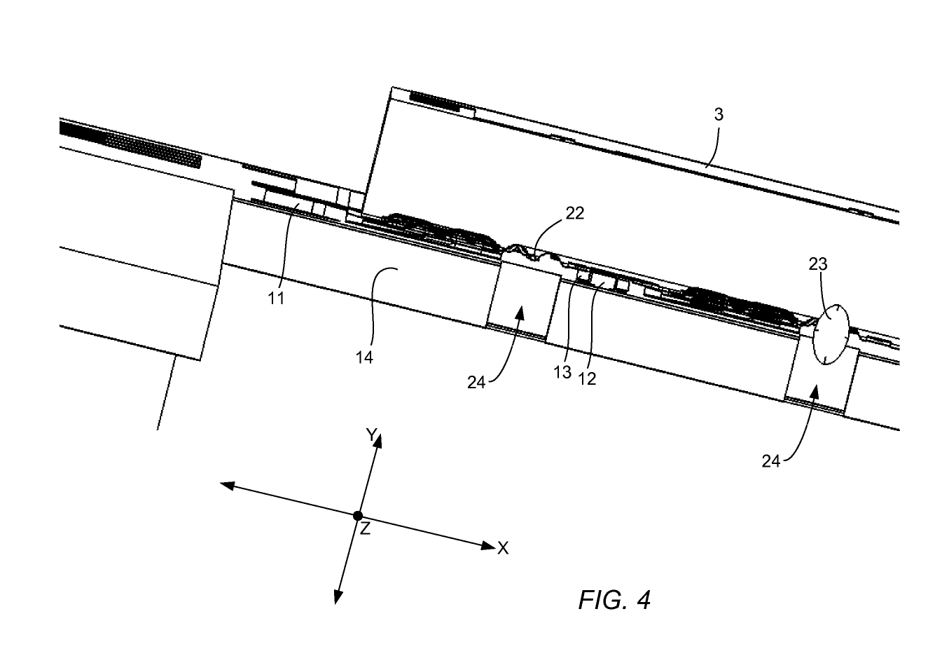

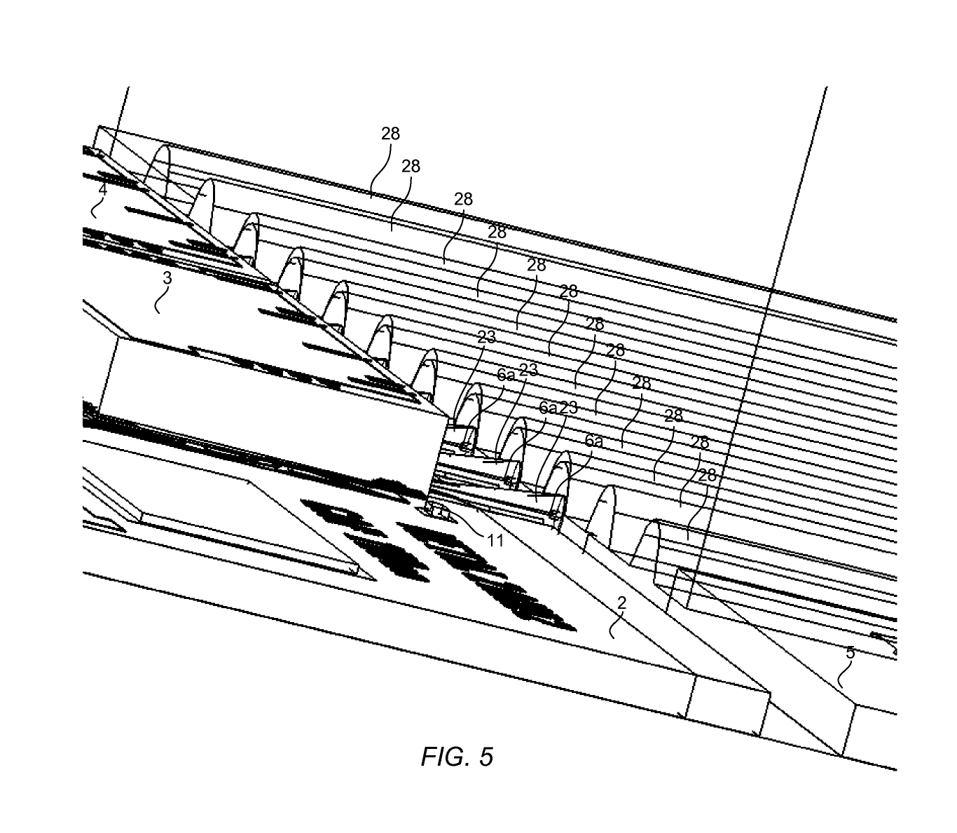

FIG. 1 illustrates a top perspective view of the parallel optical communications module 1 in accordance with an illustrative embodiment. The module 1 includes an optical bench 2 that has two optoelectronic (OE) chips 3 and 4 mounted thereon and a fiber assembly 5 that holds ends of a plurality of optical fibers 6. While eight optical fibers 6 are shown in the figures, the module 1 could be configured to use any number, N, of optical fibers, where N is a positive integer that is equal to or greater than 1. FIG. 2 illustrates a top perspective view of the optical bench 2 shown in FIG. 1 with the fiber assembly 5 and the fibers 6 removed to show details of the optical bench 2. FIG. 3 illustrates an enlarged top perspective view of the portion of the optical bench 2 shown in FIG. 2 within the dashed circle labeled 7 with the OE chips 3 and 4 and bond wires removed to allow features of the optical bench 2 to be more clearly seen. FIG. 4 illustrates an enlarged top perspective view of the portion of the optical bench 2 within the dashed circle labeled 7 in FIG. 2, but with the OE chip 3 being visible. FIG. 5 illustrates a top perspective view of the parallel optical communications module 1 shown in FIG. 1 and shows optical beams that are produced by the light sources (not shown) of the OE chips 3 and 4 and received in the ends of the cores of the optical fibers 6 held in the fiber assembly 5.

The optical bench 2 is formed using semiconductor fabrication processes, such as, for example, photolithography and etching, as will be described below in more detail. Using semiconductor fabrication techniques to form the optical bench 2 allows mating features and alignment features of the optical bench 2 to have very precise shapes and sizes and to be formed at very precisely-defined locations. The optical bench 2 is preferably made from a silicon-on-insulation (SOI) wafer, but may be made of any suitable material. An SOI wafer consists of three layers, namely, a device layer, and oxide layer and a handle layer. The device and handle layers are typically silicon. The device layer and the oxide layer thicknesses can be controlled precisely.

One of the alignment features 12 (FIGS. 3 and 4) of the optical bench 2 is used as a fiducial feature for aligning the OE chips 3 and 4 with the optical bench 2 in the X dimension during the process of mounting the OE chips 3 and 4 on the optical bench 2. Another of the alignment features 11 (FIGS. 2, 3, 4 and 5) of the optical bench 2 is used as a fiducial marking for aligning the OE chips 3 and 4 with the optical bench 2 in the Z dimension during the process of mounting the OE chips 3 and 4 on the optical bench 2. A plurality of alignment features 13 (FIGS. 3 and 4) of the optical bench 2 that are straight bars disposed equidistant from one another on the optical bench 2 are used to ensure that the OE chips 3 and 4 are seated on the optical bench at a particular height (Y-dimension). Alignment features 11, 12, and 13 comprise the first alignment feature set.

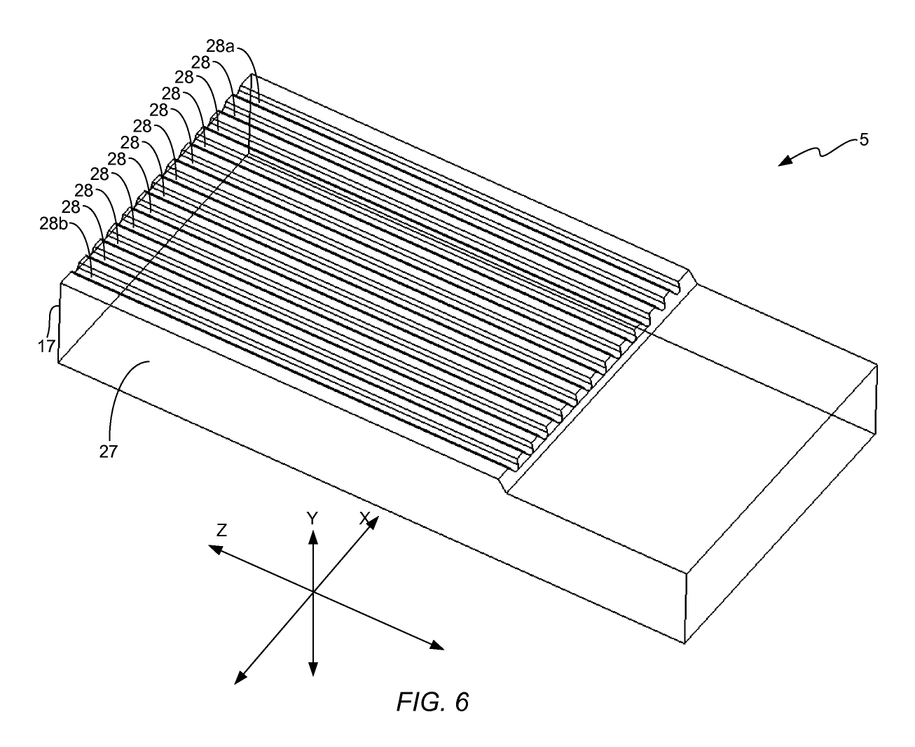

A machine vision system (not shown) is used during the process of mounting the OE chips 3 and 4 on the optical bench 2 to ensure that the OE chips 3 and 4 are precisely aligned with the fiducial features 11 and 12 and therefore precisely positioned and oriented on the optical bench 2 in the X and Z dimensions. The manner in which a machine vision system may be used for this purpose is well known and therefore will not be further described herein. The optical bench 2 has first and second grooves 15 and 16 formed therein that are used for mating the optical bench 2 with the fiber assembly 5 and for aligning the optical bench 2 with the fiber assembly 5 in the X and Y dimensions. Z-dimensional alignment of the optical bench 2 with the fiber assembly 5 is achieved by one or more surfaces of the optical bench 2 and of the fiber assembly 5 that act as stops by abutting one another in the Z directions to prevent movement of the optical bench 2 and the fiber assembly 5 toward each other in the Z direction. For example, in accordance with the illustrative embodiment, surface 14 (FIG. 3) of the optical bench 2 and surface 17 (FIGS. 6-8) of the fiber assembly 5 abut to provide Z dimensional alignment. Inner edges 15a and 16a of the grooves 15 and 16, respectively, and the abutment surface 14 of the optical bench 2 comprise the second alignment feature set.

During the process of fabricating the optical bench 2, lithographic processes are used to form the alignment and mating features 11-13, 15 and 16. A single mask (not shown) is used to define these features 11-13, 15 and 16. Using a single mask to define features 11-13, 15 and 16 ensures that they are precisely positioned and oriented relative to one another. The grooves 15 and 16 are formed by deep dry etching, which ensures that their shapes and the distance between them are very precisely controlled. As will be understood by those of skill in the art, the dry etching process can be precisely controlled to terminate at the bottom of the device layer of the SOI wafer. After the dry etching process has completed, the silicon oxide layer can be removed by wet etching to reveal the top surface of the handle wafer. As previously described, the thicknesses of the device layer and of the silicon oxide layer are precisely controlled in making the SOI wafer. Hence, the depth of the grooves 15 and 16 (i.e., the Y direction) is precisely controlled. Also, the surface 2a of the optical bench 2 in which the grooves 15 and 16 are formed is at the same height (Y-dimension) as the height of the alignment features 13 (FIG. 3).

The OE chips 3 and 4 are flip-chip mounted on the optical bench 2 such that top surfaces of the chips 3 and 4, respectively, face the top surface of the optical bench 2. A groove (not shown) is etched into the OE chips 3 and 4 such that the bottom surface of the groove is at the same Y level as the laser active spot. This groove is wider than the width of alignment feature 13. When the chips 3 and 4 are flip-chip mounted on the optical bench 2 in their aligned positions, the bottoms of the grooves of the chips 3 and 4 rest on the top surfaces 13a (FIG. 3) of the alignment features 13. Thus, the height of the alignment features 13 controls the Y position of the laser spots of the chips 3 and 4. The optical axes of the lasers 22 (FIG. 4) are at the same Y position as the surface 13a. Therefore, when the chips 3 and 4 are mounted on the optical bench 2 such that their top surfaces are in contact with the top surfaces of the alignment features 13, the lasers 22 are precisely positioned at predetermined Y positions. The lasers 22 are precisely positioned in X and Z positions through the X and Z alignment of the chips 3 and 4 with the fiducial features 11 and 12.

When the fiber assembly 5 is mounted on the optical bench 2 as shown in FIG. 5, the optical axes of the lasers (not shown) are precisely aligned with the optical axes of the respective fibers 6. The laser beams 23, therefore, couple into the ends 6a of the respective fibers 6 with very high coupling efficiency. With reference to FIGS. 3 and 4, notches 21 are formed that prevent portions of the diverging laser beams 23 (FIG. 5) from being blocked by the optical bench 2 as they propagate between the lasers 22 (FIG. 4) and the ends 6a (FIG. 5) of the respective fibers 6. If these notches 21 did not exists, portions of the diverging beams 23 would be blocked by the optical bench 2 and would not reach the ends 6a of the respective fibers 6.

As can be seen in FIG. 5, the fiber assembly 5 holds ends 6a of the fibers 6 in respective V-grooves 28 formed in the body 27 (FIG. 6) of the fiber assembly 5. As will be described below in more detail, the process by which the V-grooves 28 are formed ensures that the ends of adjacent fibers 6 are separated from one another by equal distances with an accuracy of within about ±0.1 micrometers (microns). For example, assuming for illustrative purposes that the spacing between the fibers 6 is intended to be 250 microns, the ends of adjacent fibers 6 held in the V-grooves 28 will be spaced apart by a spacing, S, equal to 250 microns±0.1 microns. The V-grooves 28 can be formed by various processes, including, for example, etching. The exact shape of the V-grooves 28 may not be perfect, but because all of the V-grooves 28 are formed by the same process under the same processing conditions, they will be identical to one another in shape and size. For this reason, the spacing between the centers of the fiber end faces is known with very high precision, i.e., within 0.1 micron.

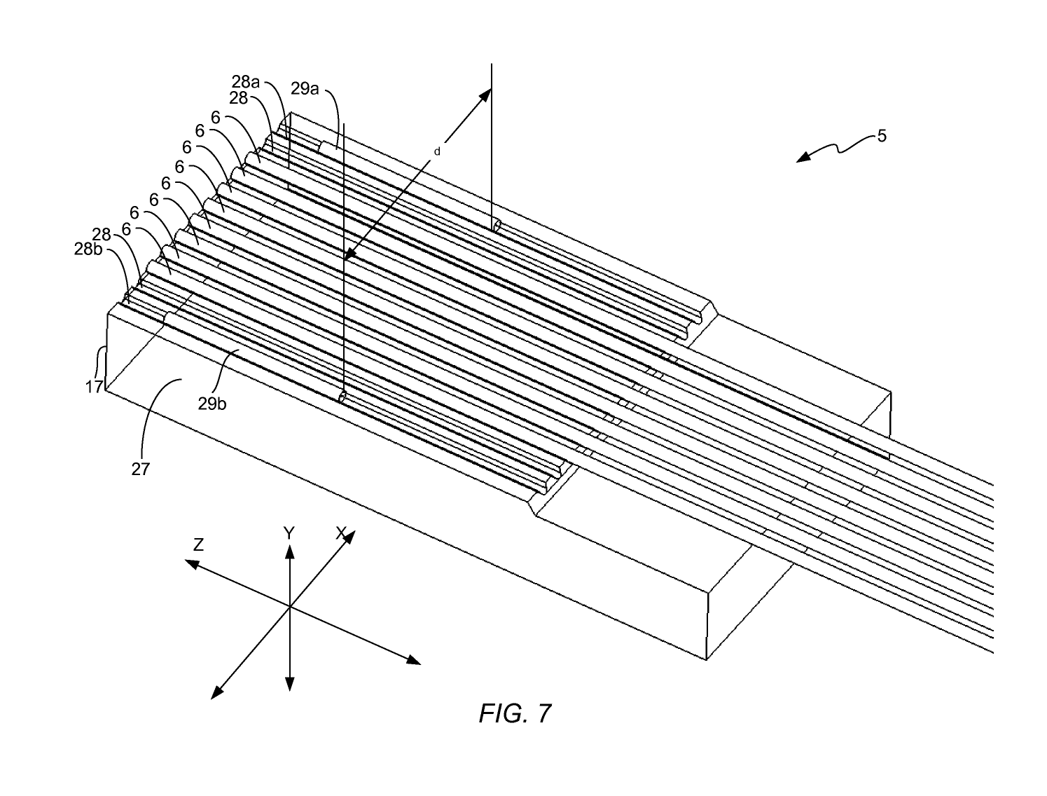

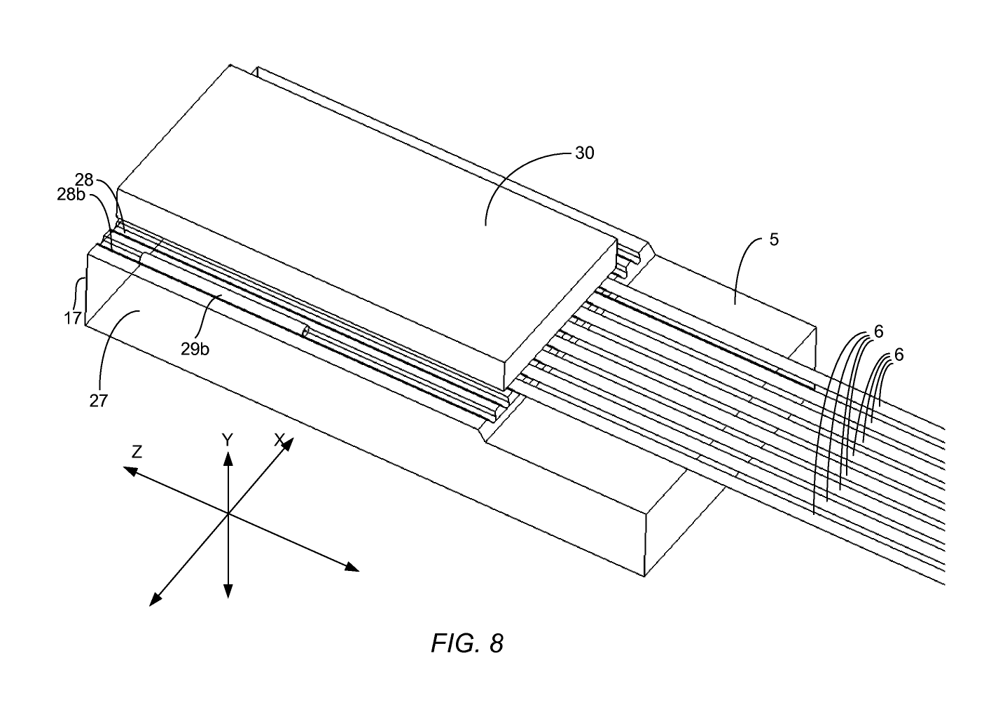

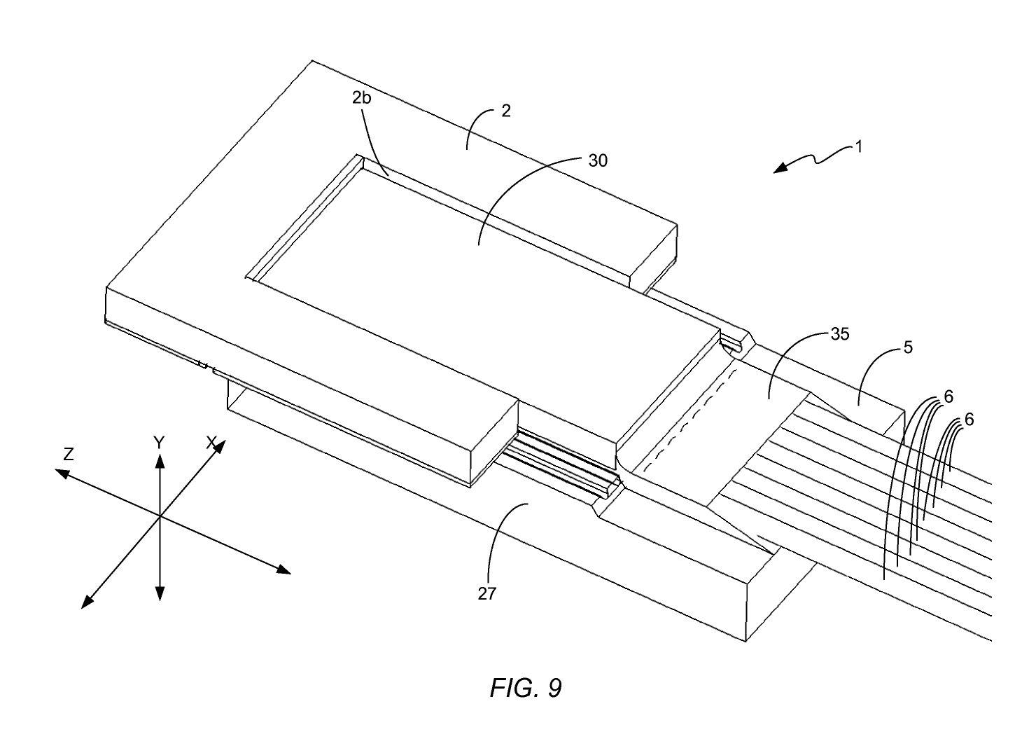

FIG. 6 illustrates a bottom perspective view of the fiber assembly 5 having the V-grooves 28 formed therein. FIG. 7 illustrates a bottom perspective view of the fiber assembly 5 having the V-grooves 28 formed in the body 27 thereof with single-mode optical fibers 6 disposed in some of the V-grooves 28 and with first and second alignment fibers 29a and 29b disposed in the outermost V-grooves 28a and 28b, respectively. FIG. 8 illustrates a bottom perspective view of the fiber assembly 5 shown in FIG. 7 after a cover 30 of the fiber assembly 5 has been secured by epoxy (not shown) to the body 27 of the fiber assembly 5. FIG. 9 illustrates a bottom perspective view of the parallel optical communications module 1 showing the epoxy 35 that is used to secure the fibers 6, 29a and 29b in the respective V-grooves 28, 28a and 28b and to secure the cover 30 to the body 27 of the fiber assembly 5. The cover 30 mates with a recess 2b formed in the optical bench 2. The cover 30 is typically, but not necessarily, made of the same material as the body 27 of the fiber assembly 5. The body 27 of the fiber assembly 5 is typically made of the same material as the optical bench 2 (e.g., silicon). The body 27 of the fiber assembly 5 and the cover 30 of the fiber assembly 5 typically have the same thickness to avoid thermal expansion differences that can cause bowing. The V-grooves 28, 28a and 28b and the cover 30 are typically made of material of the same thermal expansion property as the optical bench 2 (e.g., silicon, borosilicate glass).

The fibers 6, 29a and 29b have tightly controlled identical diameters. Therefore, when the fibers 6, 29a and 29b are disposed in their respective V-grooves 28, 28a and 28b, the centers of the end faces of the fibers 6, 29a and 29b are spaced apart from one another by equal distances within about 0.1 microns of accuracy, as described above. When the fiber assembly 5 shown in FIG. 8 is mated with the optical bench 2 shown in FIG. 2 such that alignment fibers 29a and 29b are fully engaged with the grooves 16 and 15, respectively, the ends 6a (FIG. 5) of the fibers 6 are aligned in the X, Y and Z dimensions with the respective lasers 22 (FIG. 4) of the chips 3 and 4 with an accuracy of about 0.3 microns. The distance between the inner edges 15a and 16a (FIG. 2) of the grooves 15 and 16, respectively, is controlled with very high accuracy during the etching process to ensure that the alignment of the fiber assembly 5 with the optical bench 2 in the X dimension is accurate to within tenths of a micron. The grooves 15 and 16 have a width that is greater than the diameter of the alignment fibers 29a and 29b to allow the alignment fibers 29a and 29b to easily locate the grooves 16 and 15, respectively. The distance between the inner edges 15a and 16a of the grooves 15 and 16 is equal to the inner perimeter distance, d, between the alignment fibers 29a and 29b (FIG. 7).

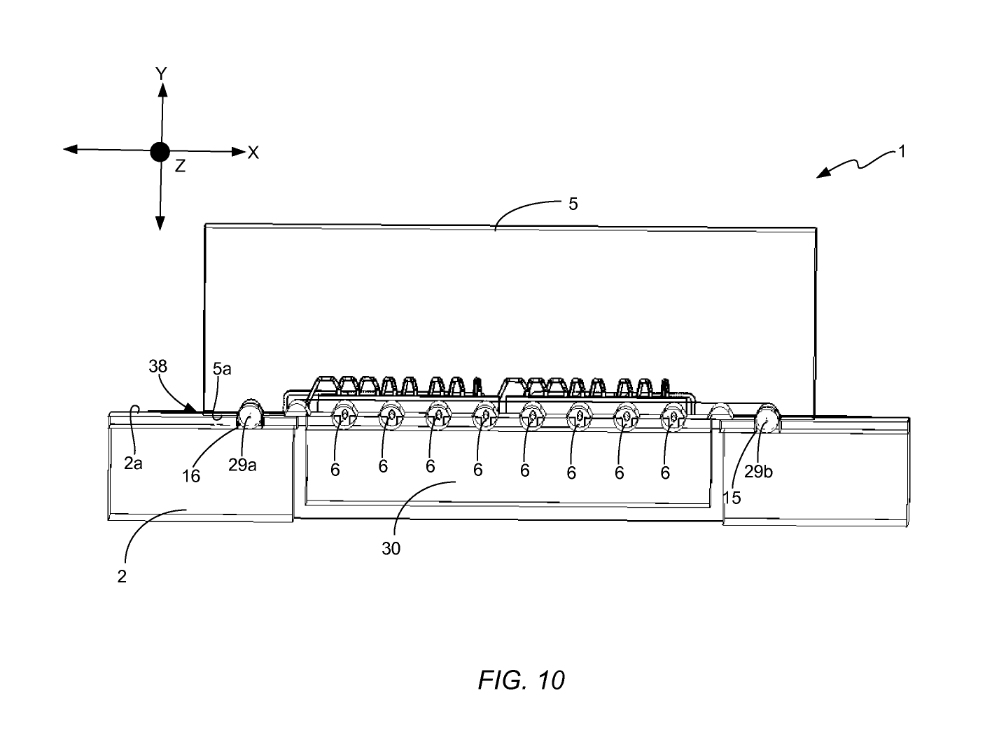

FIG. 10 illustrates a cross-sectional view of the parallel optical communications module 1 shown in FIG. 1 taken along line A-A′. It can be seen in FIG. 10 that the alignment fibers 29a and 29b are pressed against the bottoms of the grooves 16 and 15, respectively. A small gap 38 exists between the bottom surface 5a of the fiber assembly 5 and the top surface 2a of the optical bench 2, which ensures that the contact between the alignment fibers 29a and 29b and the bottoms of the grooves 16 and 15, respectively, controls Y-dimensional positioning of the fiber assembly 5 relative to the optical bench 2. Therefore, when the fiber assembly 5 is mounted on the optical bench 2 as shown in FIGS. 1, 5, 9 and 10, the mating of the alignment fibers 29a and 29b with the grooves 16 and 15, respectively, aligns the ends of the fibers 6 in the Y-dimension. As indicated above, Z-dimensional alignment of the fiber assembly 5 with the optical bench 2 is obtained by abutment of the respective surfaces 14 and 17 of the fiber assembly 5 and the optical bench 2 in the Z-directions. The alignment fibers 29a and 29b (FIG. 7) and abutment surface 17 (FIGS. 6-8) comprise the third alignment feature set.

The end faces 6a of the fibers 6 lie in the same plane. The fiber end faces 6a can be made to lie in the same plane by using well known polishing techniques to polish the ends of the fibers 6 to ensure that they lie in the same plane. Such polishing techniques can also be used to polish the abutment surface 17 of the fiber assembly 5 to ensure that the plane in which it lies is parallel to the plane in which the fiber end faces 6a lie and to ensure that the distance in the Z direction between the fiber end faces 6a and the abutment surface 17 is a precisely-defined predetermined distance. This, in turn, ensures that the fiber end faces 6a are precisely aligned with the lasers 22 in the Z dimension.

It can be seen from the above description that the illustrative embodiments described herein enable a plurality of optical fibers that can be single-mode optical fibers having very small-diameter cores (i.e., 8 to 10 microns) to be simultaneously passively aligned with a plurality of respective light sources (e.g., lasers) with sub-micron accuracy. It should be noted, however, that embodiments described herein are intended to demonstrate the principles and concepts of the invention and that the invention is not limited to these embodiment. For example, alignment and mating features that are different from those described above can be used to align the fibers with the fiber assembly, to align the lasers with the optical bench and to align the optical bench and the fiber assembly with one another. In yet another example, the optical bench 2 can be extended to allow a laser driver chip (not shown) to be flip-chip mounted on the optical bench 2 in addition to the OE chips 3 and 4 being flip-chip mounted on the optical bench 2 such that the connections between the OE chips 3 and 4 and the laser driver chip are formed with metal traces on the optical bench 2 instead of the off-optical bench wire bonds illustrated in FIG. 1. These and many other modifications can be made to the optical bench and to the fiber assembly without deviating from the scope of the invention, as will be understood by those of skill in the art in view of the description provided herein.

1. A parallel optical communications module comprising:
an optical bench (OB) having at least a first optoelectronic (OE) chip mounted on a first mounting surface thereof, said at least a first OE chip having at least N light sources, where N is a positive integer that is greater than or equal to 1, the N light sources forming at least a first array of light sources, the OB having first and second alignment feature sets integrally formed therein, the first alignment feature set being used for precisely aligning said at least a first OE chip on the OB in X, Y and Z dimensions of an X, Y, Z Cartesian coordinate system, the second alignment feature set including at least first and second alignment grooves; and
an optical fiber assembly mounted on the OB, the optical fiber assembly holding ends of at least N optical fibers in respective V-grooves of the optical fiber assembly, the optical fiber assembly having at least a third alignment feature set thereon that includes first and second alignment fibers disposed in respective V-grooves of the optical fiber assembly, the first and second alignment fibers having diameters that are identical in size to a diameter of the N optical fibers, wherein the ends of the optical fibers are held in precise positions in the optical fiber assembly relative to the third alignment feature set, the first and second alignment grooves having a width that is greater than the diameter of the first and second alignment fibers, respectively, such that the first and second alignment grooves mate with the first and second alignment fibers, respectively, and wherein the mating of the first and second alignment fibers with the first and second alignment grooves, respectively, precisely aligns the ends of the N optical fibers with respective light sources of the N light sources in at least axial directions of the optical fiber ends.

2. The parallel optical communications module of claim 1, wherein when all features of the second and third alignment feature sets are fully engaged with one another, the ends of the N optical fibers are precisely aligned with respective light sources of the N light sources in the X, Y and Z dimensions, and wherein the first array is a linear array extending in a line that is parallel to an X-axis of the X, Y, Z Cartesian coordinate system.

3. The parallel optical communications module of claim 2, wherein the V-grooves are integrally formed in the optical fiber assembly and wherein the V-grooves are parallel to one another and are parallel to a Z-axis of the X, Y, Z Cartesian coordinate system, the Z-axis being parallel to the axial directions of the optical fiber ends.

4. The parallel optical communications module of claim 3, wherein at least one abutment surface of the OB and at least one abutment surface of the optical fiber assembly abut against one another to stop movement in the Z-dimension of the OB and the fiber assembly relative to one another, and wherein the first and second V-grooves holding the first and second alignment fibers and the abutment surface of the optical fiber assembly comprise the third alignment feature set, and wherein the first and second alignment grooves formed in the OB and the abutment surface of the OB comprise the second alignment feature set, the first and second alignment grooves being parallel to one another and parallel to the Z-axis of the X, Y, Z Cartesian coordinate system.

5. The parallel optical communications module of claim 4, wherein inner edges of the first and second alignment grooves of the second alignment feature set are a preselected distance apart that is equal to an inner perimeter distance between the first and second alignment fibers of the third alignment feature set.

6. The parallel optical communications module of claim 1, wherein the first alignment feature set includes at least first and second fiducial markings that are used in aligning said at least a first OE chip on the OB in the X and Z dimensions.

7. The parallel optical communications module of claim 6, wherein the first alignment feature set includes at least one raised bar disposed on the first mounting surface, and wherein said at least a first OE chip is seated on said at least one raised bar to align said at least a first OE chip on the OB in the Y dimension.

8. The parallel optical communications module of claim 1, wherein the OB is a silicon-on-insulation (SOI) OB.

9. The parallel optical communications module of claim 1, wherein the OB and the optical fiber assembly are made of a same material.

10. The parallel optical communications module of claim 1, wherein the light sources are lasers having respective optical axes that are parallel to a Z-axis of the X, Y, Z Cartesian coordinate system.

11. The parallel optical communications module of claim 1, further comprising:
a cover that is in contact with the optical fiber assembly and that covers the V-grooves that hold the optical fibers except for the V-grooves that hold the alignment fibers, wherein an epoxy material secures the cover to the optical fiber assembly and secures the optical fibers to the respective V-grooves.

12. The parallel optical communications module of claim 11, wherein the material in which the V-grooves are formed and the material of which the cover is made have coefficients of thermal expansion that are closely matched to a coefficient of thermal expansion of glass.

13. A method for simultaneously passively aligning ends of a plurality of optical fibers with respective light sources in a parallel optical communications module, the method comprising:
providing an optical bench (OB) having at least a first optoelectronic (OE) chip mounted on a first mounting surface thereof the OB, said at least a first OE chip having at least N light sources, where N is a positive integer that is greater than or equal to 1, the N light sources forming at least a first array of light sources, the OB having first and second alignment feature sets integrally formed therein, the first alignment feature set being used for precisely aligning said at least a first OE chip on the OB in X, Y and Z dimensions of an X, Y, Z Cartesian coordinate system, the second alignment feature set including at least first and second alignment grooves; and
mounting an optical fiber assembly on the OB, the optical fiber assembly holding ends of at least N optical fibers in respective V-grooves of the optical fiber assembly, the optical fiber assembly having at least a third alignment feature set thereon that includes first and second alignment fibers disposed in respective V-grooves of the optical fiber assembly, the first and second alignment fibers having diameters that are identical in size to a diameter of the N optical fibers, the ends of the optical fibers being precisely positioned in the optical fiber assembly relative to the third alignment feature set, and wherein the mounting of the optical fiber assembly on the OB causes the first and second alignment grooves to mate with the first and second alignment fibers, respectively, and wherein the mating of the first and second alignment fibers with the first and second alignment grooves, respectively, precisely aligns the ends of the N optical fibers with respective light sources of the N light sources in at least axial directions of the optical fiber ends.

14. The method of claim 13, wherein when all features of the second and third alignment feature sets are fully engaged with one another, the ends of the N optical fibers are precisely aligned with respective light sources of the N light sources in the X, Y and Z dimensions, and wherein the first array is a linear array extending in a line that is parallel to an X-axis of the X, Y, Z Cartesian coordinate system.

15. The method of claim 14, wherein the V-grooves are integrally formed in the optical fiber assembly, wherein the V-grooves are parallel to one another and are parallel to a Z-axis of the X, Y, Z Cartesian coordinate system, the Z-axis being parallel to the axial directions of the optical fiber ends.

16. The method of claim 15, wherein at least one abutment surface of the OB and at least one abutment surface of the optical fiber assembly abut against one another to stop movement in the Z-dimension of the OB and the optical fiber assembly relative to one another, and wherein the first and second V-grooves holding the first and second alignment fibers and the abutment surface of the optical fiber assembly comprise the third alignment feature set, and wherein the first and second alignment grooves are parallel to one another and parallel to the Z-axis of the X, Y, Z Cartesian coordinate system.

17. The method of claim 16, wherein inner edges of the first and second alignment grooves of the second alignment feature set are a preselected distance apart that is equal to an inner perimeter distance between the first and second alignment fibers of the third alignment feature set.

18. The method of claim 13, wherein the first alignment feature includes at least first and second fiducial markings that are used in aligning said at least a first OE chip on the OB in the X and Z dimensions.

19. The method of claim 18, wherein the first alignment feature set includes at least one raised bar disposed on the first mounting surface, and wherein said at least a first OE chip is seated on said at least one raised bar to align said at least a first OE chip on the OB in the Y dimension.

20. The method of claim 13, wherein the OB is a silicon-on-insulation (SOI) OB.

21. The method of claim 13, wherein the OB and the optical fiber assembly are made of a same material.

22. The method of claim 13, wherein the light sources are lasers having respective optical axes that are parallel to a Z-axis of the X, Y, Z Cartesian coordinate system.

23. The method of claim 17, wherein a cover is in contact with the optical fiber assembly and covers the V-grooves that hold the optical fibers except for the V-grooves that hold the alignment fibers, wherein an epoxy material secures the cover to the optical fiber assembly and secures the optical fibers to the respective V-grooves.

24. The method of claim 23, wherein the material in which the V-grooves are formed and the material of which the cover is made have coefficients of thermal expansion that are closely matched to a coefficient of thermal expansion of glass.

25. The method of claim 13, wherein the optical fibers are single-mode optical fibers having core diameters that are equal to or less than about 10 micrometers.

26. A parallel optical communications module comprising:
an optical bench (OB) having at least a first optoelectronic (OE) chip mounted on a first mounting surface thereof, the OB being made of a first material, said at least a first OE chip having at least N light sources, where N is a positive integer that is greater than or equal to 1, the N light sources forming at least a first array of light sources, the OB having first and second alignment feature sets integrally formed therein, the first alignment feature set being used for precisely aligning said at least a first OE chip on the OB in X, Y and Z dimensions of an X, Y, Z Cartesian coordinate system; and
an optical fiber assembly mounted on the OB, the optical fiber assembly being made of the first material, the optical fiber assembly holding ends of at least N optical fibers, the optical fiber assembly having at least a third alignment feature set thereon, wherein the ends of the optical fibers are held in precise positions in the optical fiber assembly relative to the third alignment feature set, and wherein the third alignment feature set is fully engaged with the second alignment feature set, and wherein the full engagement of the second and third alignment feature sets with one another precisely aligns the ends of the N optical fibers with respective light sources of the N light sources in the X, Y and Z dimensions.

27. The parallel optical communications module of claim 26, wherein the first material comprises silicon.
